(19) United States
(12) Patent Application Publication
(10) Pub. No.: US 2015/0248879 A1
(43) Pub. Date: Sep. 3, 2015

(54) METHOD AND SYSTEM FOR CONFIGURING AN ACTIVE NOISE CANCELLATION UNIT

(71) Applicant: Texas Instruments Incorporated, Dallas, TX (US)

(72) Inventors: Jorge Francisco Arbona Miskimen, Dallas, TX (US); Nitish Krishna Murthy, Allen, TX (US); Srivatsan Agaram Kandadai, Santa Clara, CA (US); Matthew Raymond Kucic, Santa Clara, CA (US); Edwin Randolph Cole, Dallas, TX (US)

(21) Appl. No.: 14/193,974

(22) Filed: Feb. 28, 2014

(51) Int. Cl. G10K 11/178

(52) U.S. Cl. CPC G10K 11/178

(57) ABSTRACT

An active noise cancellation (“ANC”) unit receives audio signals from a user-operated device through a connection. In response to the audio signals, the ANC unit causes at least one speaker to generate sound waves. The ANC unit receives a set of parameters from the user-operated device through the connection. The connection is at least one of: an audio cable; and a wireless connection. The set of parameters represents a user-specified combination of ANC properties. The ANC unit automatically adapts itself to implement the set of parameters for substantially achieving the user-specified combination of ANC properties in operations of the ANC unit.

### BACKGROUND

The disclosures herein relate in general to audio processing, and in particular to a method and system for configuring an active noise cancellation unit.

Conventionally, active noise cancellation (“ANC”) properties of an audio headset are configurable by manual operation of physical switches (e.g., push buttons) on the headset and/or by the headset's receiving of configuration information through a universal serial bus (“USB”). The physical switches are potentially cumbersome, inflexible and/or confusing to operate. The USB relies upon a separate USB cable, which is potentially inconvenient.

### SUMMARY

An active noise cancellation (“ANC”) unit receives audio signals from a user-operated device through a connection. In response to the audio signals, the ANC unit causes at least one speaker to generate sound waves. The ANC unit receives a set of parameters from the user-operated device through the connection. The connection is at least one of: an audio cable; and a wireless connection. The set of parameters represents a user-specified combination of ANC properties. The ANC unit automatically adapts itself to implement the set of parameters for substantially achieving the user-specified combination of ANC properties in operations of the ANC unit.

### BRIEF DESCRIPTION OF THE DRAWINGS

FIG. 1 is a perspective view of a mobile smartphone that includes an information handling system of the illustrative embodiments.

FIG. 2 is a block diagram of the system of FIG. 1.

FIG. 3 is a block diagram of a headset.

FIG. 4 is an example image that is displayed by a display device of FIG. 1.

FIG. 5 is a flowchart of an operation of the system of FIG. 1.

FIG. 6 is a flowchart of an operation of the headset of FIG. 3.

### DETAILED DESCRIPTION

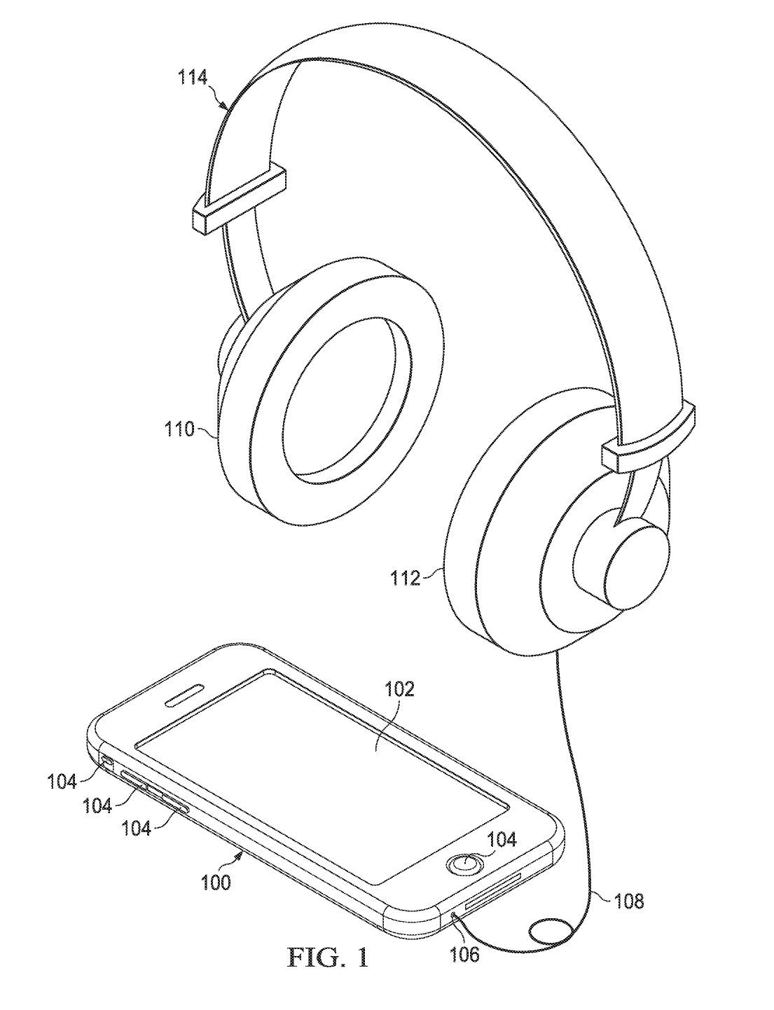

FIG. 1 is a perspective view of a mobile smartphone that includes an information handling system 100 of the illustrative embodiments. In this example, as shown in FIG. 1, the system 100 includes a user-operated touchscreen 102 (on a front of the system 100) and various user-operated switches 104 for manually controlling operations of the system 100. Also, the system 100 includes an audio output port 106 for outputting analog audio signals (e.g., representing music and/or other sounds) through a cable 108 (e.g., conventional 3.5 mm audio cable) to one or more speakers, such as speakers 110 and 112 of an audio headset 114. In the illustrative embodiments, the various components of the system 100 are housed integrally with one another.

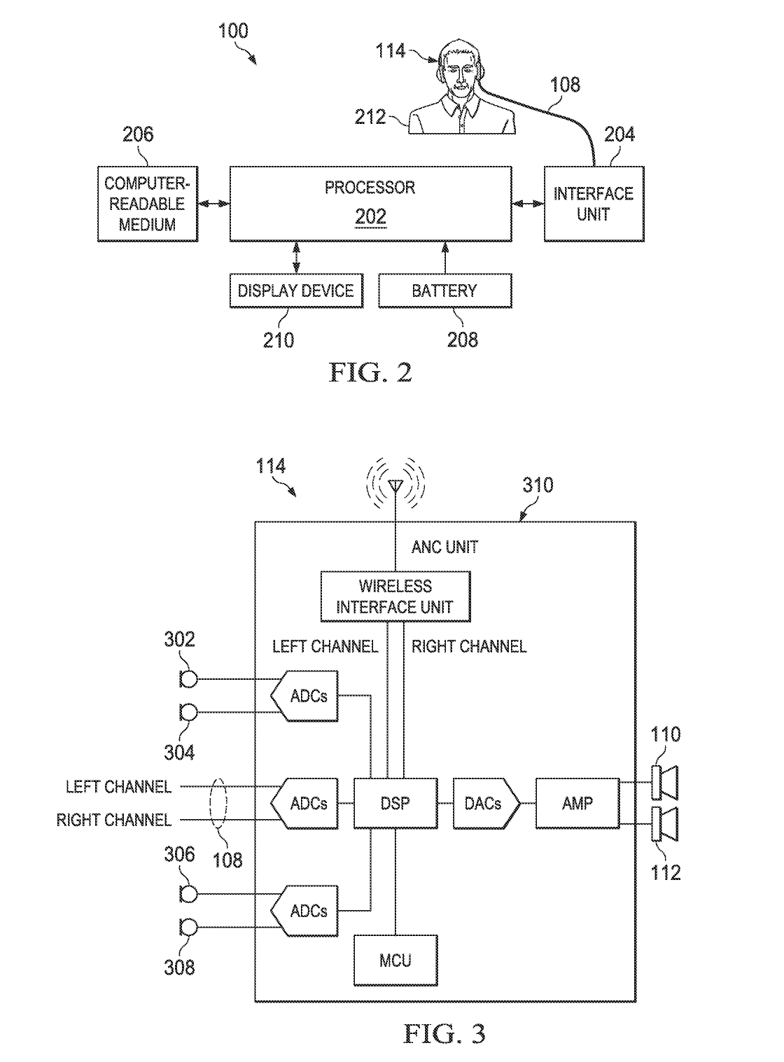

FIG. 2 is a block diagram of the system 100. The system 100 includes various electronic circuitry components for performing the system 100 operations, implemented in a suitable combination of software, firmware and hardware. Such components include: (a) a processor 202 (e.g., one or more microprocessors, microcontrollers and/or digital signal processors), which is a general purpose computational resource for executing instructions of computer-readable software programs to process data (e.g., a database of information) and perform additional operations (e.g., communicating information) in response thereto; (b) an interface unit 204 for communicating information to and from a network and other devices in response to signals from the processor 202; (c) a computer-readable medium 206, such as a nonvolatile storage device and/or a random access memory (“RAM”) device, for storing those programs and other information; (d) a battery 208, which is a source of power for the system 100; (e) a display device 210 (e.g., the touchscreen 102) that includes a screen for displaying information to a human user 212 and for receiving information from the user 212 in response to signals from the processor 202; and (f) other electronic circuitry for performing additional operations.

In the example of FIG. 2, the processor 202 outputs (via the interface unit 204) analog audio signals to one or more speakers (e.g., speakers of the headset 114) through: (a) the cable 108, which is a wired connection; and/or (b) a wireless (e.g., BLUETOOTH) connection. In response to those analog audio signals, those speaker(s) output sound waves (at least some of which are audible to the user 212). In the illustrative embodiments, the various electronic circuitry components of the system 100 are housed integrally with one another.

As shown in FIG. 2, the processor 202 is connected to the computer-readable medium 206, the battery 208, and the display device 210. For clarity, although FIG. 2 shows the battery 208 connected to only the processor 202, the battery 208 is further coupled to various other components of the system 100. Also, the processor 202 is coupled through the interface unit 204 to the network (not shown in FIG. 2), such as a Transport Control Protocol/Internet Protocol (“TCP/IP”) network (e.g., the Internet or an intranet). For example, the interface unit 204 communicates information by outputting information to, and receiving information from, the processor 202 and the network, such as by transferring information (e.g. instructions, data, signals) between the processor 202 and the network (e.g., wirelessly or through a USB interface).

The system 100 operates in association with the user 212. In response to signals from the processor 202, the screen of the display device 210 displays visual images, which represent information, so that the user 212 is thereby enabled to view the visual images on the screen of the display device 210. In one embodiment, the display device 210 is a touchscreen (e.g., the touchscreen 102), such as: (a) a liquid crystal display (“LCD”) device; and (b) touch-sensitive circuitry of such LCD device, so that the touch-sensitive circuitry is integral with such LCD device. Accordingly, the user 212 operates the touchscreen 102 (e.g., virtual keys thereof, such as a virtual keyboard and/or virtual keypad) for specifying information (e.g., alphanumeric text information) to the processor 202, which receives such information from the touchscreen 102.

For example, the touchscreen 102: (a) detects presence and location of a physical touch (e.g., by a finger of the user 212, and/or by a passive stylus object) within a display area of the touchscreen 102; and (b) in response thereto, outputs signals (indicative of such detected presence and location) to the processor 202. In that manner, the user 212 can touch (e.g., single tap and/or double tap) the touchscreen 102 to: (a) select a portion (e.g., region) of a visual image that is then-currently displayed by the touchscreen 102; and/or (b) cause the touchscreen 102 to output various information to the processor 202.

FIG. 3 is a block diagram of the headset 114. The headset 114 includes: (a) the speaker 110, which is located on an interior side of a left earset of the headset 114 (“left ear region”); and (b) the speaker 112, which is located on an interior side of a right earset of the headset 114 (“right ear region”).

In the example of FIG. 3: (a) an error microphone 302 is located within the left ear region; and (b) a reference microphone 304 is located outside the left ear region (e.g., on an exterior side of the left earset of the headset 114). The error microphone 302: (a) converts, into signals, sound waves from the left ear region (e.g., including sound waves from the left speaker 110); and (b) outputs those signals. The reference microphone 304: (a) converts, into signals, sound waves from outside the left ear region (e.g., ambient noise around the reference microphone 304); and (b) outputs those signals. Accordingly, the signals from the error microphone 302 and the reference microphone 304 represent various sound waves (collectively “left sounds”).

Similarly: (a) an error microphone 306 is located within the right ear region; and (b) a reference microphone 308 is located outside the right ear region (e.g., on an exterior side of the right earset of the headset 114). The error microphone 306: (a) converts, into signals, sound waves from the right ear region (e.g., including sound waves from the right speaker 112); and (b) outputs those signals. The reference microphone 308: (a) converts, into signals, sound waves from outside the right ear region (e.g., ambient noise around the reference microphone 308); and (b) outputs those signals. Accordingly, the signals from the error microphone 306 and the reference microphone 308 represent various sound waves (collectively “right sounds”).

Also, the headset 114 includes an active noise cancellation (“ANC”) unit 310. The ANC unit 310: (a) receives and processes the signals from the error microphone 302 and the reference microphone 304; and (b) in response thereto, outputs signals for causing the left speaker 110 to generate first additional sound waves that cancel at least some noise in the left sounds. Similarly, the ANC unit 310: (a) receives and processes the signals from the error microphone 306 and the reference microphone 308; and (b) in response thereto, outputs signals for causing the right speaker 112 to generate second additional sound waves that cancel at least some noise in the right sounds.

In one example, the ANC unit 310 optionally: (a) receives a left channel of the analog audio signals from the processor 202 (“left audio”) through the cable 108 and/or a wireless (e.g., BLUETOOTH) interface unit; and (b) combines the left audio into the signals that the ANC unit 310 outputs to the left speaker 110 (collectively “left speaker signals”). Accordingly, in this example: (a) the left speaker 110 generates the first additional sound waves to also represent the left audio's information (e.g., music and/or speech), which is audible to a left ear of the user 212; and (b) the ANC unit 310 suitably accounts for the left audio in its further processing (e.g., estimating noise) of the signals from the error microphone 302 for cancelling at least some noise in the left sounds.

Similarly, the ANC unit 310 optionally: (a) receives a right channel of the analog audio signals from the processor 202 (“right audio”) through the cable 108 and/or the wireless interface unit; and (b) combines the right audio into the signals that the ANC unit 310 outputs to the right speaker 112 (collectively “right speaker signals”). Accordingly, in this example: (a) the right speaker 112 generates the second additional sound waves to also represent the right audio's information (e.g., music and/or speech), which is audible to a right ear of the user 212; and (b) the ANC unit 310 suitably accounts for the right audio in its further processing (e.g., estimating noise) of the signals from the error microphone 306 for cancelling at least some noise in the right sounds.

As shown in FIG. 3, via analog-to-digital converters (“ADCs”), a digital signal processor (“DSP”) of the ANC unit 310 receives the left sounds (from the microphones 302 and 304), the right sounds (from the microphones 306 and 308), the left audio (from the cable 108) and the right audio (from the cable 108). The ADCs convert analog versions of those signals into digital versions thereof, which the ADCs output to the DSP. The DSP processes the left sounds, the right sounds, the left audio and the right audio for: (a) cancelling at least some noise in the left sounds, and combining the left audio into the left speaker signals, as discussed hereinabove; and (b) cancelling at least some noise in the right sounds, and combining the right audio into the right speaker signals, as discussed hereinabove.

Accordingly, digital-to-analog converters (“DACs”) receive digital versions of the left speaker signals and the right speaker signals from the DSP. The DACs convert those digital versions into analog versions thereof, which the DACs output to an amplifier (“Amp”). The Amp: (a) receives and amplifies those analog versions from the DACs; and (b) outputs such amplified versions to the speakers 110 and 112.

Also, the ANC unit 310 includes a microcontroller (“MCU”) for configuring the DSP and various other components of the ANC unit 310. For clarity, although FIG. 2 shows the MCU connected to only the DSP, the MCU is further coupled to various other components of the ANC unit 310. In the example of FIG. 3, the DSP and the MCU include their own respective computer-readable media (e.g., cache memories) for storing computer-readable software programs and other information.

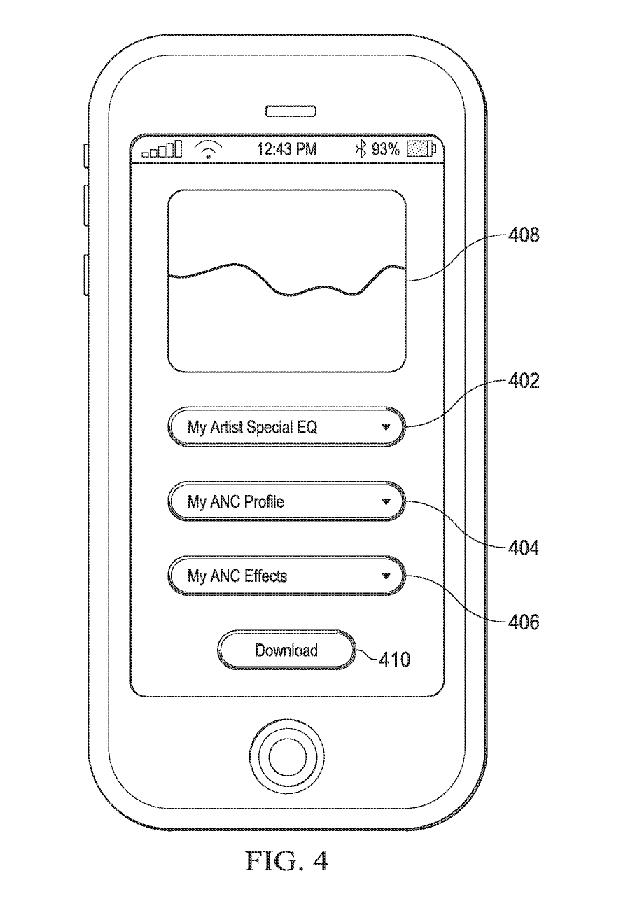

FIG. 4 is an example image that is displayed by a screen of the display device 210. The processor 202 causes the display device 210 to display such image, in response to processing (e.g., executing) instructions of a software program (e.g., software application), and in response to information (e.g., commands) received from the user 212 (e.g., via the touchscreen 102 and/or the switches 104). The example image of FIG. 4 includes menus 402, 404 and 406 (e.g., pull-down menus), a window 408, and a download button 410.

By suitably operating the menu 402 through the display device 210 (e.g., by selecting from among predefined equalization profiles within the menu 402), the user 212 specifies its preferred equalization profile for sound waves from the speakers 110 and 112. Also, by suitably operating the menu 404 through the display device 210 (e.g., by selecting from among predefined ANC profiles within the menu 404), the user 212 specifies its preferred ANC profile for those sound waves. Further, by suitably operating the menu 406 through the display device 210 (e.g., by selecting from among predefined ANC effects within the menu 406), the user 212 specifies its preferred ANC effect(s) for those sound waves.

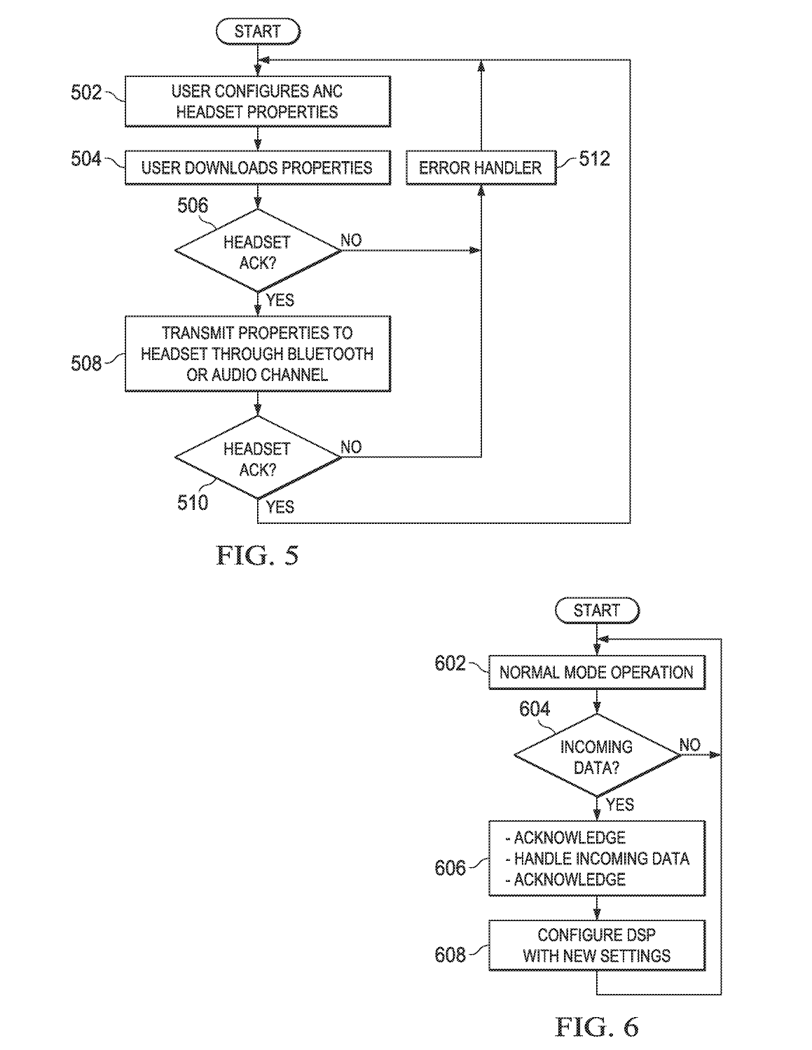

In response to a combination of those specifications by the user 212 (e.g., the user 212′s preferred equalization profile via the menu 402, combined with the user 212′s preferred ANC profile via the menu 404, combined with the user 212′s preferred ANC effect(s) via the menu 406), the processor 202 causes the window 408 to show an example graphical representation of how those sound waves could be affected by such combination. Accordingly, such combination is a user-specified combination of ANC properties, including the user-specified equalization profile, ANC profile and ANC effect(s). After the user 212 is satisfied with such combination of ANC properties, the user 212 informs the processor 202 of such fact by suitably operating (e.g., touching) the download button 410, as discussed hereinbelow in connection with FIG. 5.

FIG. 5 is a flowchart of an operation of the system 100. At a step 502, the user 212 configures ANC properties of the headset 114 by specifying such combination via the menus 402, 404 and 406 (FIG. 4). Such combination is associated with a respective set of component parameters, which the headset 114 is suitable for implementing to substantially achieve such combination of ANC properties. Accordingly, those parameters represent such combination of ANC properties.

At a next step 504, the user 212 suitably operates the download button 410 (FIG. 4) to inform the processor 202 that the user 212 is satisfied with such combination. Accordingly, at the step 504, in response to such combination and the user 212 suitably operating the download button 410, the processor 202: (a) reads (e.g., from the computer-readable medium 206) such combination's respective set of component parameters; and (b) through the cable 108 and/or the wireless (e.g., BLUETOOTH) interface unit (FIG. 3), outputs a message to the headset 114 for initiating a download of those component parameters from the processor 202 to the headset 114 (“initiate download message”). If those component parameters are not already stored by the computer-readable medium 206, then the processor 202 automatically requests, receives and reads those component parameters from the network (e.g., TCP/IP network, such as the Internet or an intranet) through the interface unit 204.

At a next step 506, the processor 202 determines whether the headset 114 acknowledges its receipt of the initiate download message. In one example, the headset 114 outputs such acknowledgement to the processor 202 through the cable 108 and/or the wireless (e.g., BLUETOOTH) connection. In response to the processor 202 receiving such acknowledgement from the headset 114 within a predetermined window of time after the initiate download message, the operation continues from the step 506 to a step 508.

At the step 508, the processor 202 transmits such combination's respective set of component parameters to the headset 114 through the cable 108 and/or the wireless (e.g., BLUETOOTH) interface unit (FIG. 3). At a next step 510, the processor 202 determines whether the headset 114 acknowledges its receipt of those component parameters. In one example, the headset 114 outputs such acknowledgement to the processor 202 through the cable 108 and/or the wireless (e.g., BLUETOOTH) connection. In response to the processor 202 receiving such acknowledgement from the headset 114 within a predetermined window of time after such transmission of those component parameters, the operation returns from the step 510 to the step 502.

Referring again to the step 506, if the processor 202 does not receive the headset 114 acknowledgement within the predetermined window of time after the initiate download message, then the operation continues from the step 506 to a step 512. Similarly, if the processor 202 does not receive the headset 114 acknowledgement within a predetermined window of time after such transmission of those component parameters, then the operation continues from the step 510 to the step 512. At the step 512, the processor 202 executes a suitable error handler program, and the operation returns to the step 502.

FIG. 6 is a flowchart of an operation of the headset 114. At a step 602, the headset 114 performs its normal operations, as discussed hereinabove in connection with FIG. 3. At a next step 604, the headset 114 determines whether it is receiving an initiate download message (step 504 of FIG. 5) from the processor 202.

In response to the headset 114 determining that it is not receiving an initiate download message from the processor 202, the operation returns from the step 604 to the step 602. Conversely, in response to the headset 114 determining that it is receiving an initiate download message from the processor 202, the operation continues from the step 604 to a step 606. At the step 606, the headset 114: (a) outputs an acknowledgement (acknowledging its receipt of the initiate download message) to the processor 202 through the cable 108 and/or the wireless (e.g., BLUETOOTH) connection; (b) receives a combination's respective set of component parameters (step 508 of FIG. 5) from the processor 202; and (c) outputs an acknowledgement (acknowledging its receipt of those component parameters) to the processor 202 through the cable 108 and/or the wireless (e.g., BLUETOOTH) connection.

At a next step 608, in response to those component parameters, the headset 114 automatically adapts itself (e.g., configures software and/or hardware of its MCU, DSP and/or various other components of the ANC unit 310) to implement those component parameters for substantially achieving the user-specified combination of ANC properties in the headset 114 operations (discussed hereinabove in connection with FIG. 3). After the step 608, the operation returns to the step 602.

Accordingly, the processor 202 and the headset 114 communicate the following types of information to and from one another through the cable 108 and/or the wireless (e.g., BLUETOOTH) connection:
(a) conventional audio signals from the processor 202 to the headset 114;
(b) the initiate download message from the processor 202 to the headset 114;
(c) the component parameters from the processor 202 to the headset 114; and
(d) acknowledgements thereof from the headset 114 to the processor 202.

In one embodiment, all such information is communicated through the same connection, namely either: (a) the cable 108, which is a wired connection; or (b) the wireless (e.g., BLUETOOTH) connection. In such embodiment, the initiate download message, the component parameters, and the acknowledgements thereof (and information represented by such message, parameters and acknowledgements) are inaudible to ears of the user 212, even if the user 212 listens to the sound waves from the speakers 110 and 112, and even if the conventional audio signals (and/or information represented by those signals) are audible to such ears.

In one example, for inaudible communication through the cable 108 (e.g., a conventional three-conductor stereo cable), the transmitting device (e.g., processor 202 or headset 114) generates and outputs two types of inaudible tones, namely: (a) a clock tone through a first conductor of such cable; and (b) a data tone through a second conductor of such cable. With a sharp bandpass filter or a fast Fourier transform (“FFT”), the receiving device (e.g., headset 114 or processor 202) monitors magnitudes of those tones. In such monitoring, the receiving device applies a threshold to quantize each tone as being either a binary logic “1” signal or a binary logic “0” signal.

To start a particular communication, the transmitting device generates and outputs a first predefined sequence of tones for sending a header (e.g., preamble) of such communication to the receiving device. After such header, the transmitting device generates and outputs suitable tones for sending: (a) respective addresses of the transmitting and receiving devices; and (b) payload data of such communication to the receiving device. To end the particular communication, the transmitting device generates and outputs a second predefined sequence of tones for sending a footer of such communication to the receiving device. In this example, each byte has a 1-bit cyclic redundancy check (“CRC”). Accordingly, the processor 202 and the headset 114 are suitable for operating the audio cable 108 (and, similarly, operating the wireless connection) as a binary interface for ultrasonically communicating information with a serial communications protocol.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method of configuring an active noise cancellation (“ANC”) unit, the method comprising:
with the ANC unit: receiving audio signals from a user-operated device through a connection; in response to the audio signals, causing at least one speaker to generate sound waves; receiving a set of parameters from the user-operated device through the connection, wherein the set of parameters represents a user-specified combination of ANC properties; and automatically adapting the ANC unit to implement the set of parameters for substantially achieving the user-specified combination of ANC properties in operations of the ANC unit;
wherein the connection is at least one of: an audio cable; and a wireless connection.

2. The method of claim 1, wherein automatically adapting the ANC unit includes: automatically adapting the ANC unit to implement the set of parameters for substantially achieving the user-specified combination of ANC properties in the operations of the ANC unit, wherein the operations include the causing of the at least one speaker to generate the sound waves.

3. The method of claim 1, wherein receiving the set of parameters from the user-operated device through the connection includes: receiving the set of parameters in a manner that is inaudible to the user, even if the user listens to the sound waves.

4. The method of claim 3, wherein the connection is the audio cable.

5. The method of claim 4, wherein the audio cable is a three-conductor stereo cable.

6. The method of claim 3, wherein the connection is the wireless connection.

7. The method of claim 6, wherein the wireless connection is a wireless BLUETOOTH connection.

8. The method of claim 1, and comprising:
with the user-operated device: receiving the user-specified combination of ANC properties from the user; and reading the set of parameters in response to the user-specified combination of ANC properties.

9. The method of claim 8, wherein receiving the user-specified combination of ANC properties from the user includes:
displaying one or more menus on a screen of the user-operated device; and
receiving the user-specified combination of ANC properties from the user via the one or more menus.

10. The method of claim 8, wherein reading the set of parameters includes:
reading the set of parameters through a network interface unit of the user-operated device.

11. A system, comprising:
an active noise cancellation (“ANC”) unit for: receiving audio signals from a user-operated device through a connection; in response to the audio signals, causing at least one speaker to generate sound waves; receiving a set of parameters from the user-operated device through the connection, wherein the set of parameters represents a user-specified combination of ANC properties; and automatically adapting the ANC unit to implement the set of parameters for substantially achieving the user-specified combination of ANC properties in operations of the ANC unit;
wherein the connection is at least one of: an audio cable; and a wireless connection.

12. The system of claim 11, wherein automatically adapting the ANC unit includes: automatically adapting the ANC unit to implement the set of parameters for substantially achieving the user-specified combination of ANC properties in the operations of the ANC unit, wherein the operations include the causing of the at least one speaker to generate the sound waves.

13. The system of claim 11, wherein receiving the set of parameters from the user-operated device through the connection includes: receiving the set of parameters in a manner that is inaudible to the user, even if the user listens to the sound waves.

14. The system of claim 13, wherein the connection is the audio cable.

15. The system of claim 14, wherein the audio cable is a three-conductor stereo cable.

16. The system of claim 13, wherein the connection is the wireless connection.

17. The system of claim 16, wherein the wireless connection is a wireless BLUETOOTH connection.

18. The system of claim 11, wherein the user-operated device is for: receiving the user-specified combination of ANC properties from the user; and reading the set of parameters in response to the user-specified combination of ANC properties.

19. The system of claim 18, wherein receiving the user-specified combination of ANC properties from the user includes:
displaying one or more menus on a screen of the user-operated device; and
receiving the user-specified combination of ANC properties from the user via the one or more menus.

20. The system of claim 18, wherein reading the set of parameters includes:
reading the set of parameters through a network interface unit of the user-operated device.

21. A system, comprising:
at least one speaker for generating sound waves;
a user-operated device for receiving a user-specified combination of ANC properties from the user, reading a set of parameters in response to the user-specified combination of ANC properties, and outputting audio signals and the set of parameters through a connection, wherein the connection is at least one of: an audio cable; and a wireless connection; and
an active noise cancellation (“ANC”) unit for: receiving the audio signals from the user-operated device through the connection; in response to the audio signals, causing the at least one speaker to generate the sound waves; receiving the set of parameters from the user-operated device through the connection in a manner that is inaudible to the user, even if the user listens to the sound waves; and automatically adapting the ANC unit to implement the set of parameters for substantially achieving the user-specified combination of ANC properties in operations of the ANC unit, wherein the operations include the causing of the at least one speaker to generate the sound waves.

22. The system of claim 21, wherein the connection is the audio cable.

23. The system of claim 22, wherein the audio cable is a three-conductor stereo cable.

24. The system of claim 21, wherein the connection is the wireless connection.

25. The system of claim 24, wherein the wireless connection is a wireless BLUETOOTH connection.

26. The system of claim 21, wherein receiving the user-specified combination of ANC properties from the user includes:
displaying one or more menus on a screen of the user-operated device; and
receiving the user-specified combination of ANC properties from the user via the one or more menus.

27. The system of claim 21, wherein reading the set of parameters includes:
reading the set of parameters through a network interface unit of the user-operated device.
